(19) United States
(12) Patent Application Publication
(10) Pub. No.: US 2026/0117809 A1
(43) Pub. Date: Apr. 30, 2026

(54) TELESCOPIC PIPE WITH TOOTHED LOCKING STRUCTURE

(71) Applicant: Guangdong Jinjie Technology Co., Ltd, Zhongshan (CN)

(72) Inventors: HONGBIN ZHANG, Zhongshan (CN); JINHUA LU, Zhongshan (CN)

(21) Appl. No.: 19/033,408

(22) Filed: Jan. 21, 2025

(30) Foreign Application Priority Data
Oct. 25, 2024 (CN) 202411502899.7

(51) Int. Cl. F16B 7/10

(52) U.S. Cl. CPC F16B 7/105

(57) ABSTRACT

A telescopic pipe with a toothed locking structure is provided, which includes a front pipe and a rear pipe. The rear pipe has an adjustment hole and a plurality of limit teeth, the limit teeth are spaced apart in a length direction of the adjustment hole to form a plurality of limit grooves. One end of the front pipe is inserted into the adjustment hole and can move relative to the rear pipe along the adjustment hole. One end of the front pipe inserted into the rear pipe is movably connected to a clamp block that is inserted and matched with the limit grooves. When the front pipe moves relative to the rear pipe, the clamp block is driven away from the limit grooves by the limit teeth and moved into another adjacent limit grooves, so that the front pipe can be locked and unlocked in its moving direction.

### CROSS-REFERENCE TO RELATED APPLICATIONS

This application claims priority to Chinese Patent Application No. 202411502899.7, filed on October 25, 2024, which is hereby incorporated by reference in its entirety.

### TECHNICAL FIELD

The present disclosure relates to the field of photographic equipment technologies, and in particular, to a telescopic pipe with a toothed locking structure.

### BACKGROUND

The telescopic rod is a support rod with an adjustable length widely used in the field of photography equipment, such as selfie sticks, tripods, etc. The existing telescopic rod is composed of a plurality of pipe fittings that are sequentially connected. In adjacent two pipe fittings, one pipe fitting is equipped with a socket, and the other pipe fitting is equipped with a clamp block that can move relative to the pipe fitting in a radial direction. In a storage state, the clamp block is retracted into the pipe fitting and offset axially from the socket. In a stretched state, the clamp block is protruded from the pipe fitting and is inserted into the socket, thereby locking the two pipe fittings in the stretched state. However, due to the pairing of one clamp block with one socket, the stretching length of the telescopic rod is fixed, rendering it inconvenient to use.

The purpose of the present disclosure is to provide a telescopic pipe with a toothed locking structure, which solves problems of the existing telescopic rod being locked in a telescopic state through a clamp block and a socket, with a fixed stretching length and inconvenient use.

The present disclosure is implemented through the following technical solutions.

A telescopic pipe with a toothed locking structure, including a plurality of sequentially connected pipe fittings; where in adjacent two pipe fittings, one pipe fitting is defined as a front pipe, and the other pipe fitting is defined as a rear pipe; where the rear pipe has an adjustment hole and a plurality of limit teeth; the plurality of limit teeth are protruded from a wall of the adjustment hole and are spaced apart in a length direction of the adjustment hole to form a plurality of limit grooves; one end of the front pipe is inserted into the adjustment hole and is capable of moving relative to the rear pipe along the adjustment hole, where one end of the front pipe inserted into the rear pipe is movably connected with a clamp block that matches with the limit grooves, when the front pipe moves relative to the rear pipe, the clamp block is driven to move away from the limit grooves by the limit teeth and move into another adjacent limit groove.

In some embodiments of the present disclosure, the limit grooves have a front pushing surface, the front pushing surface is located in front of the clamp block when the clamp block is inserted and matched with the limit grooves; the front pushing surface is inclined from an interior to an outside towards the back; the clamp block has a rear pushing surface that is matched with the front pushing surface; the limit grooves have a rear contact surface, which is located behind the clamp block when the clamp block is inserted and matched with the limit grooves; the rear contact surface is extended radially along the front pipe; the clamp block has a front contact surface that abuts against a front and a rear of the rear contact surface; the front contact surface and the rear contact surface are parallel to each other.

In some embodiments of the present disclosure, the limit grooves have a rear contact surface, which is located behind the clamp block when the clamp block is inserted and matched with the limit grooves; the rear contact surface is extended radially along the front pipe; the clamp block has a front contact surface that abuts against a front and a rear of the rear contact surface; the front contact surface and the rear contact surface are parallel to each other.

In some embodiments of the present disclosure, the front pipe is provided with an elastic member that drives the clamp block to move into the limit grooves; a positioning hole is formed on the clamp block configured for one end of the elastic member being inserted.

In some embodiments of the present disclosure, the front pipe is capable of being rotated relative to the rear pipe to cause the clamp block to move away from the limit grooves in a circumferential direction of the front pipe; a reset piece is provided on the front pipe and the rear pipe; when the front pipe rotates relative to the rear pipe, the reset piece causes the front pipe to rotate reverse, so that the clamp block is moved, reset and clamped into the limit grooves.

In some embodiments of the present disclosure, the front pipe is provided with a front connector that moves and rotates synchronously with the front pipe; the adjustment hole is provided with a rear connector that rotates synchronously with the rear pipe; the rear connector is rotatably connected to the front connector and is capable of moving synchronously with the front pipe relative to the rear pipe; the reset piece is a torsion spring with one end connected to the front connector and the other end connected to the rear connector; the front connector is provided with the clamp block and the elastic member that drives the clamp block to move into the limit grooves.

In some embodiments of the present disclosure, the front connector and the rear connector are enclosed to form a receiving cavity for accommodating the reset piece; the front connector is provided with a front fixing hole configured for one end of the reset piece being inserted, and the rear connector is provided with a rear fixing hole configured for the other end of the reset piece being inserted.

In some embodiments of the present disclosure, the front pipe is provided with a through hole configured for the clamp block to pass through; the front connector is provided with a guide hole configured for the clamp block and the elastic member to be inserted; the clamp block is extended or retracted from the through hole along the guide hole into the front pipe.

In some embodiments of the present disclosure, the plurality of limit teeth spaced apart in the length direction of the adjustment hole form the limit gear rack; the rear connector is provided with a limit gear groove that cooperates with the limit gear rack to limit a rotation of the rear connector relative to the rear pipe.

In some embodiments of the present disclosure, the front pipe is spaced apart from a wall of the adjustment hole to form an assembly gap; one end of the front pipe inserted into the rear pipe is provided with a damping plate accommodated in the assembly gap; there are two damping plates, and the two damping plates are arranged opposite to each other in the radial direction of the front pipe to form a guiding gap that cooperates with the limit gear rack; one end of the rear pipe is provided with a stopper configured for the front pipe to be inserted; a part of the stopper is extended into the adjustment hole to limit the front pipe to move away from the rear pipe by abutting against front and rear of the damping plates.

The advantage of this technical solution lies in a configuration of the plurality of limit teeth spaced intervals inside the rear pipe to form the plurality of limit grooves, and providing the clamp block on the front pipe that is inserted and matched with the limit grooves, the clamp block is driven to move away from the limit grooves and move into another adjacent limit groove by the limit teeth when the front pipe moves relative to the rear pipe, so that the front pipe can be locked and unlocked in its moving direction. That is, when the front pipe moves relative to the rear pipe, it can be locked in various expansion and contraction lengths through a cooperation of one locking block and the plurality of limit grooves, with diverse stretching lengths and convenient use.

### BRIEF DESCRIPTION OF DRAWINGS

FIG. 1 is a perspective view of a telescopic pipe.

FIG. 2 is a front view of the telescopic pipe.

FIG. 3 is a sectional view taken at A-A in FIG. 2, where a clamp block is inserted and matched with a limit groove.

FIG. 4 is an enlarged partial view of D in FIG. 3.

FIG. 5 is an enlarged partial view of E in FIG. 4.

FIG. 6 is a sectional view taken at A-A in FIG. 2, where the clamp block is moved away from the limit groove.

FIG. 7 is an enlarged partial view of F in FIG. 6.

FIG. 8 is a sectional view taken at B-B in FIG. 2.

FIG. 9 is a sectional view taken at C-C in FIG. 2.

FIG. 10 is an exploded view of the telescopic pipe.

FIG. 11 is an enlarged partial view of G in FIG. 10.

### DESCRIPTION OF EMBODIMENTS

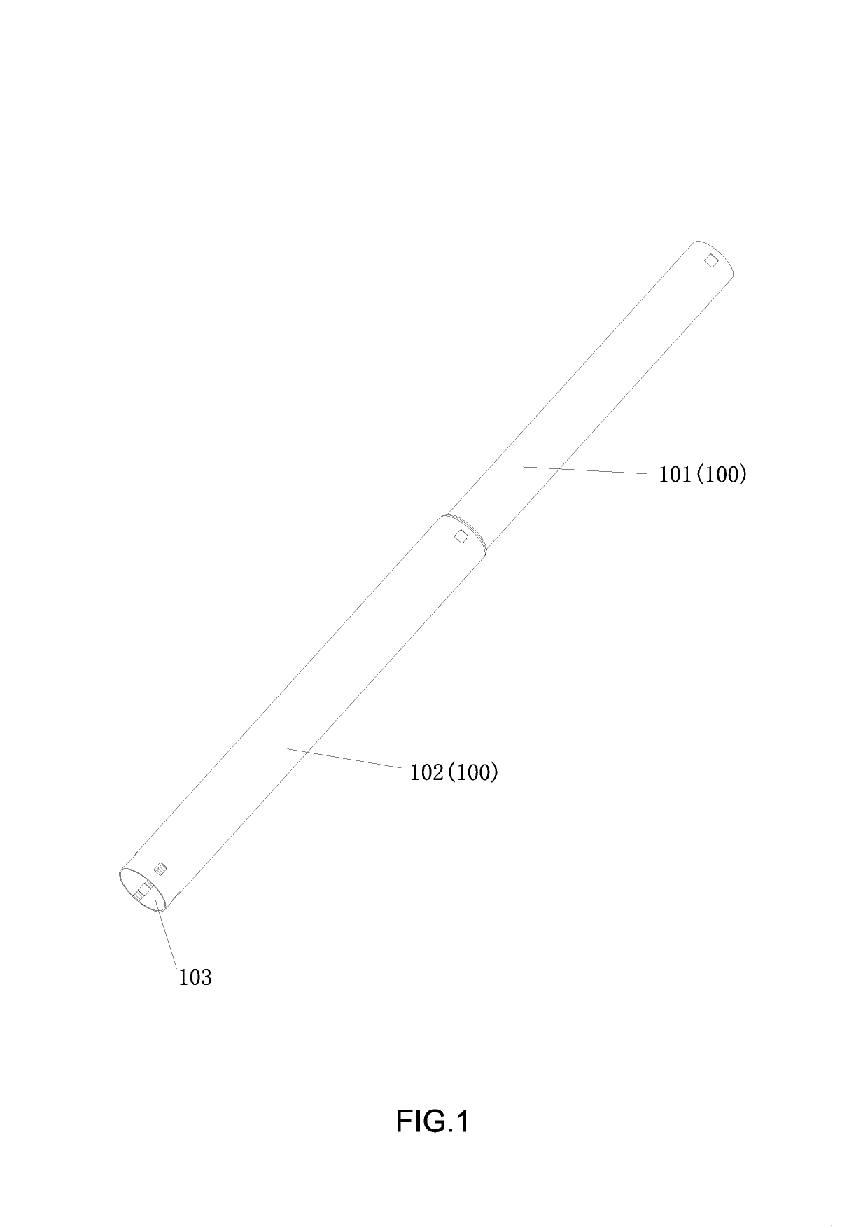

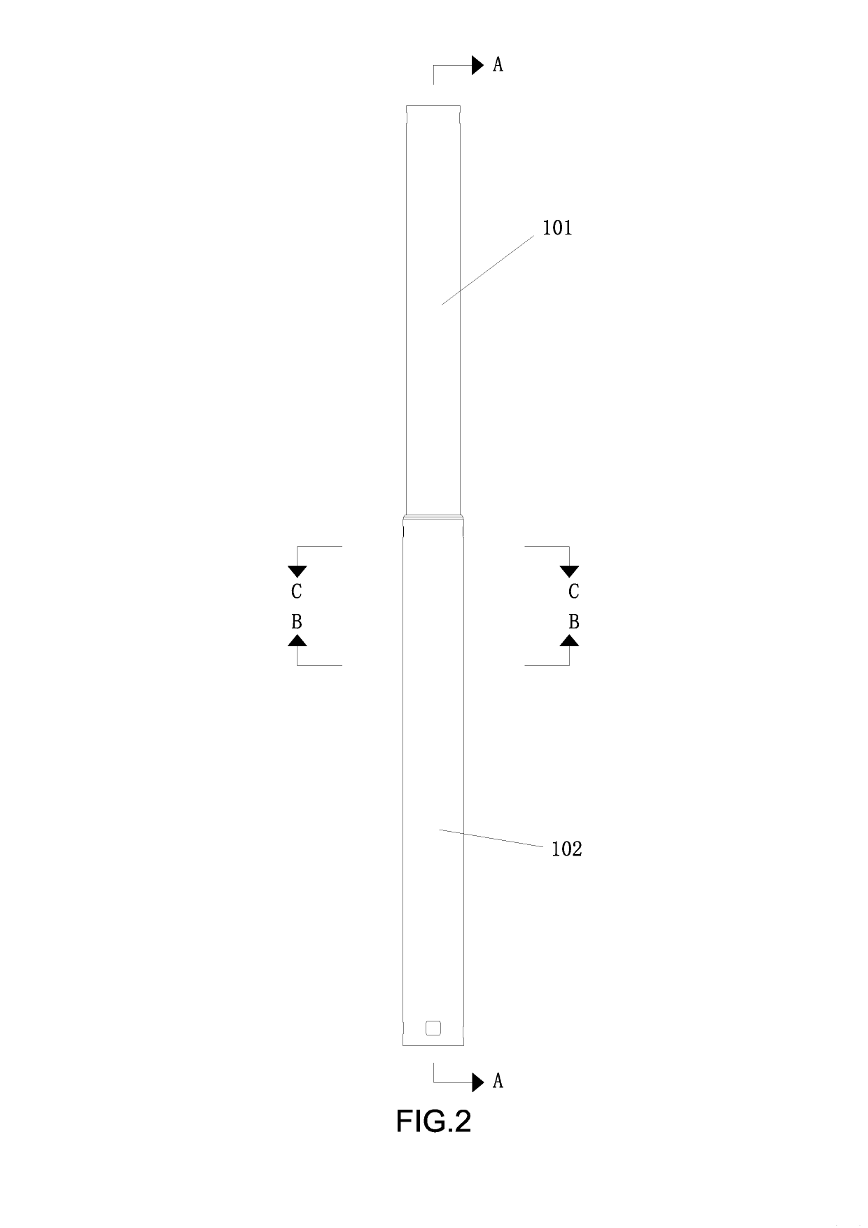

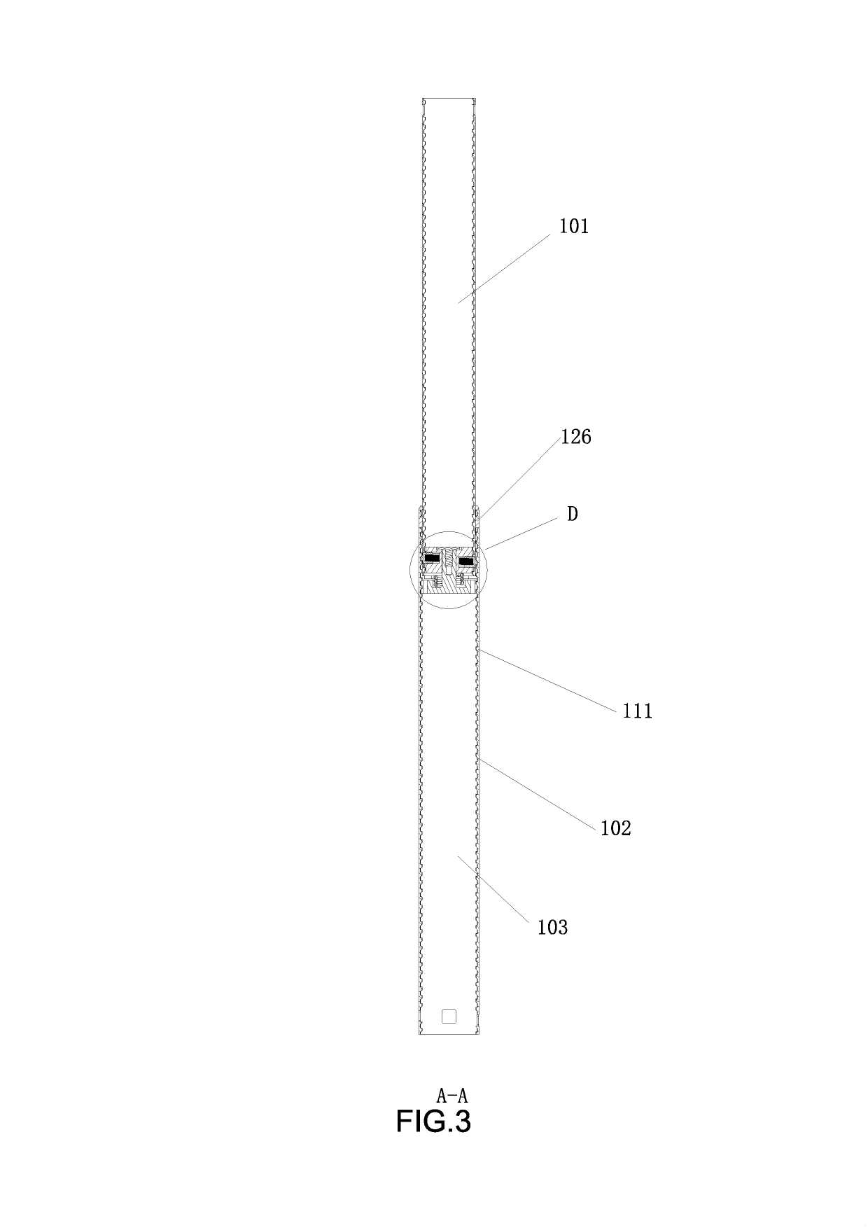

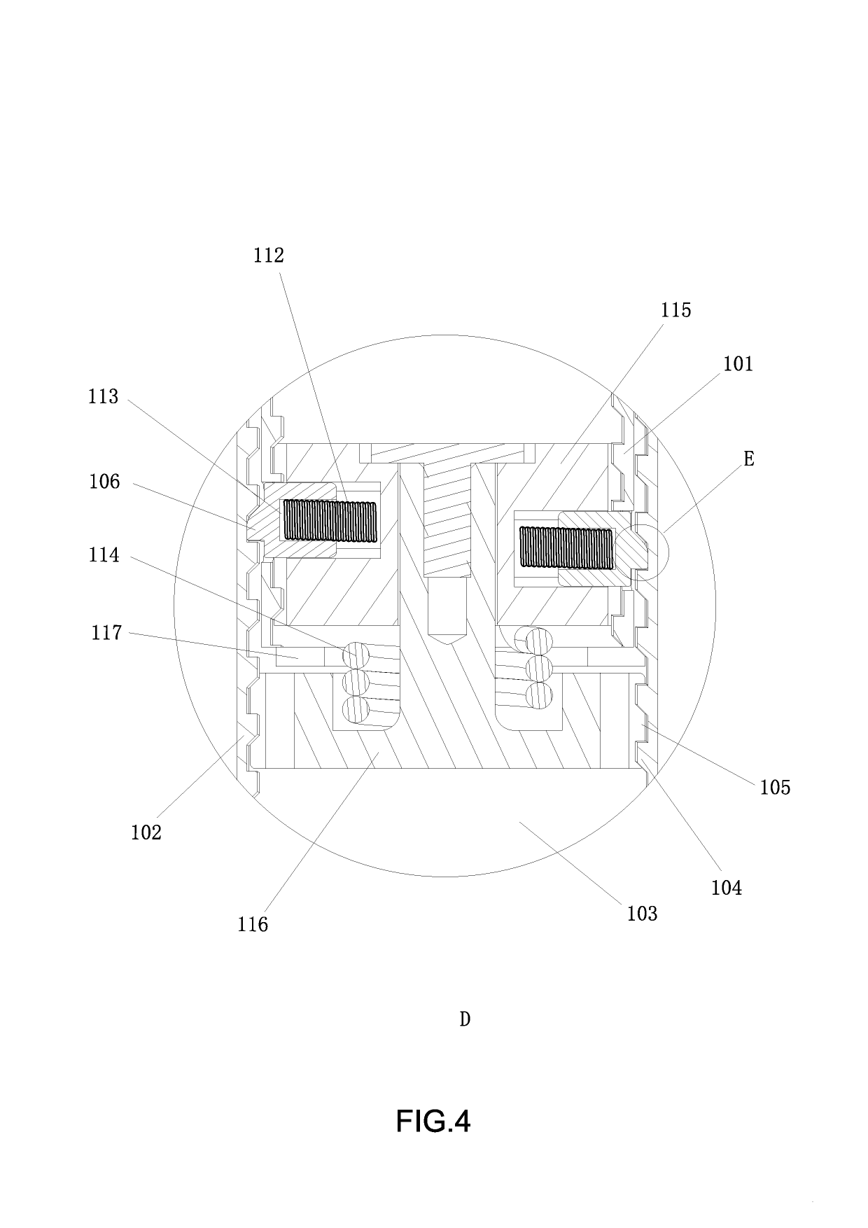

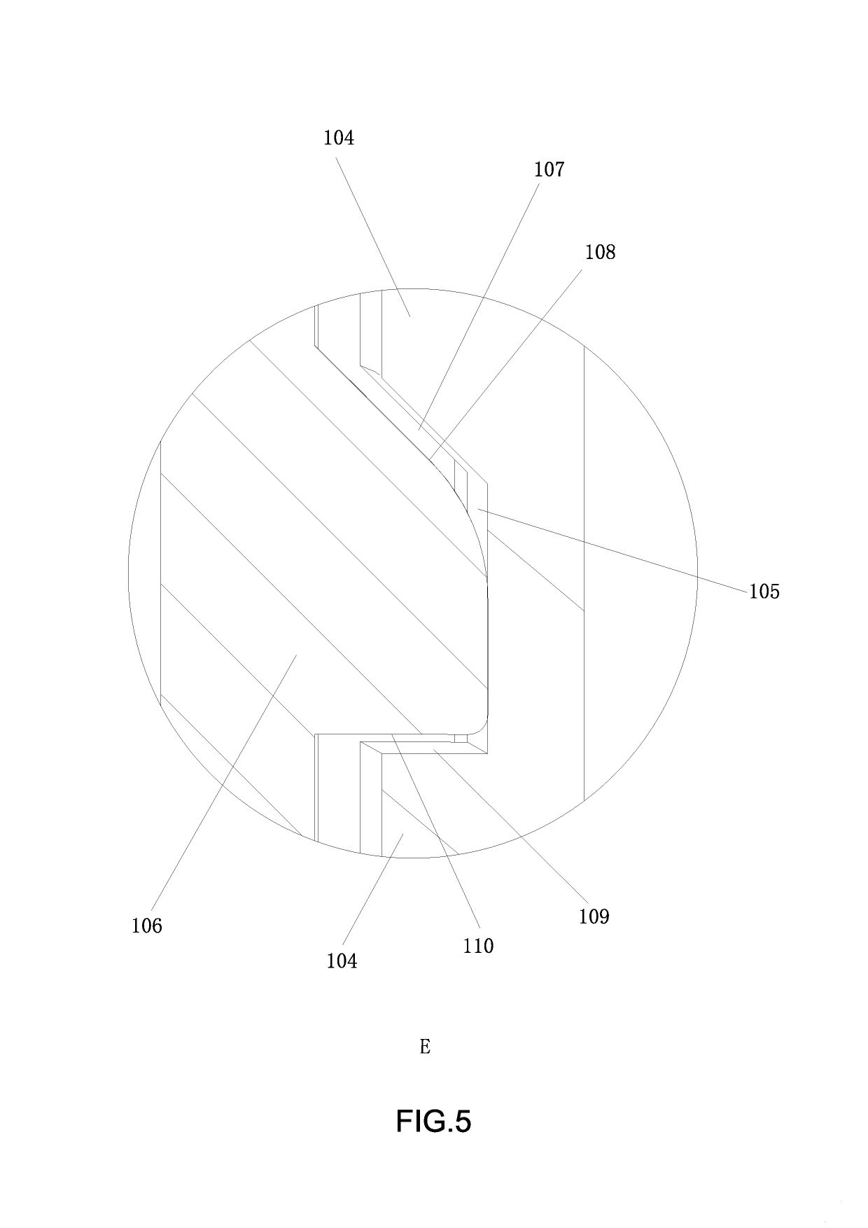

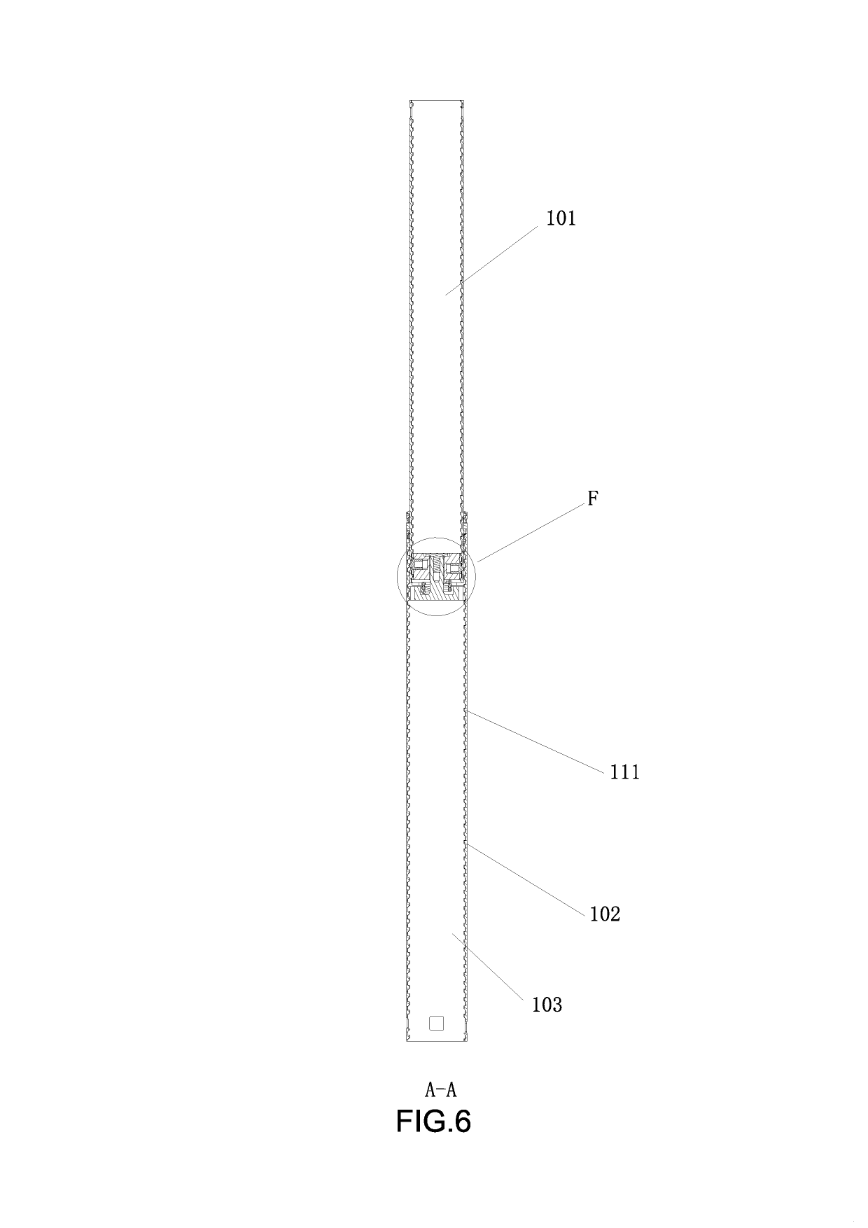

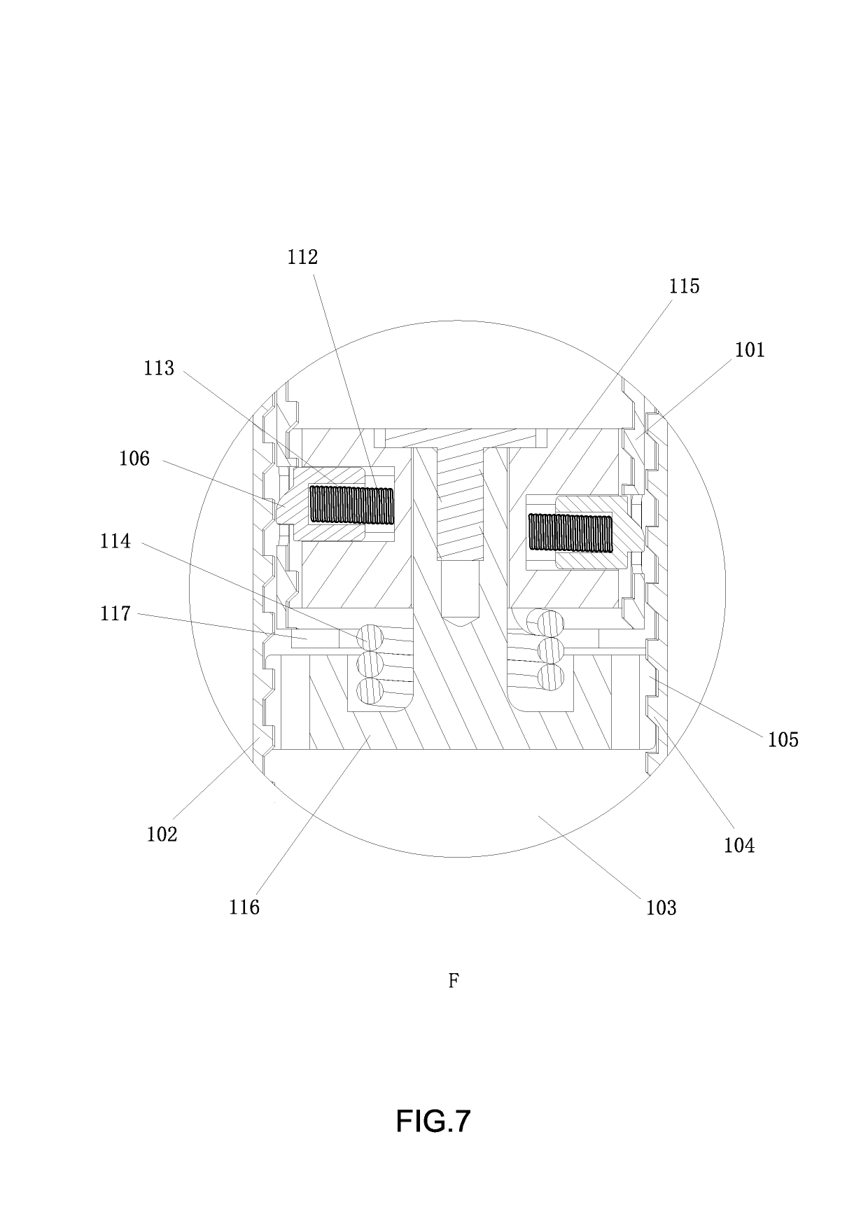

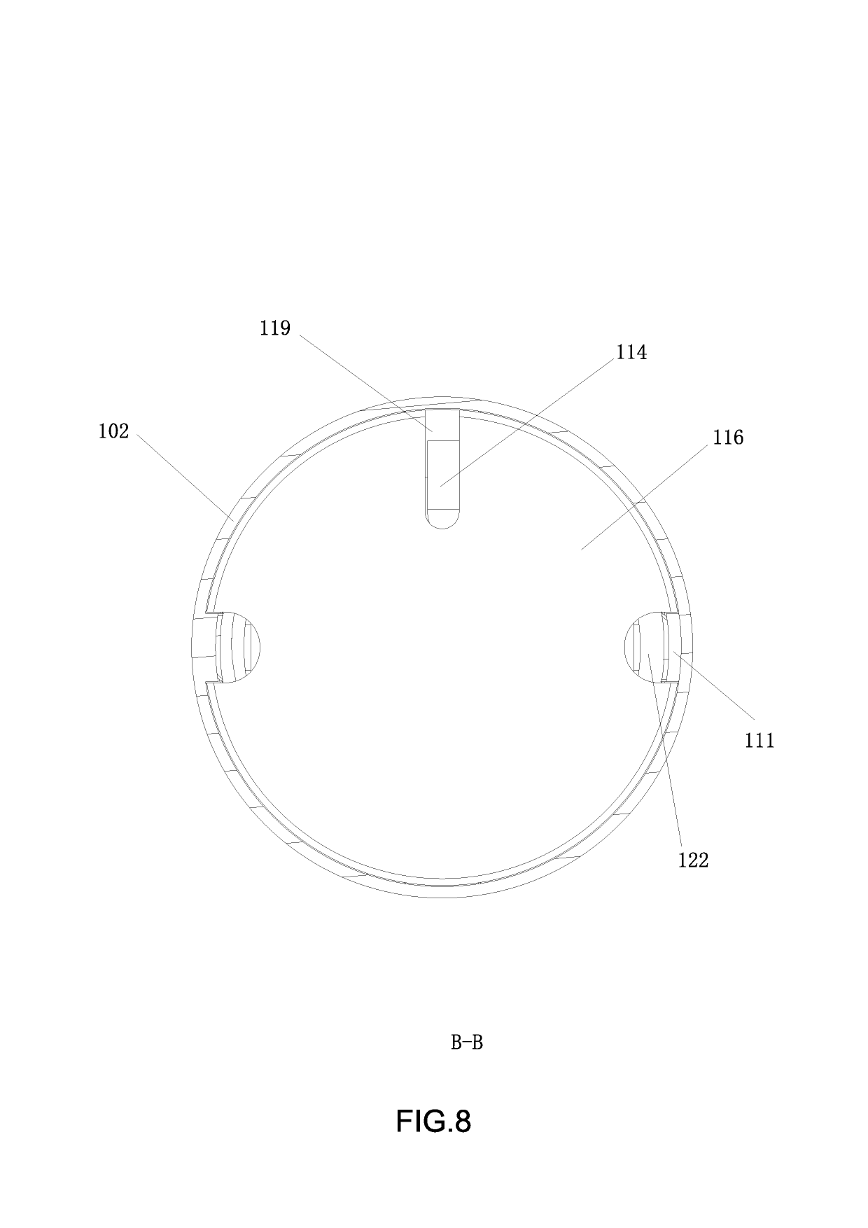

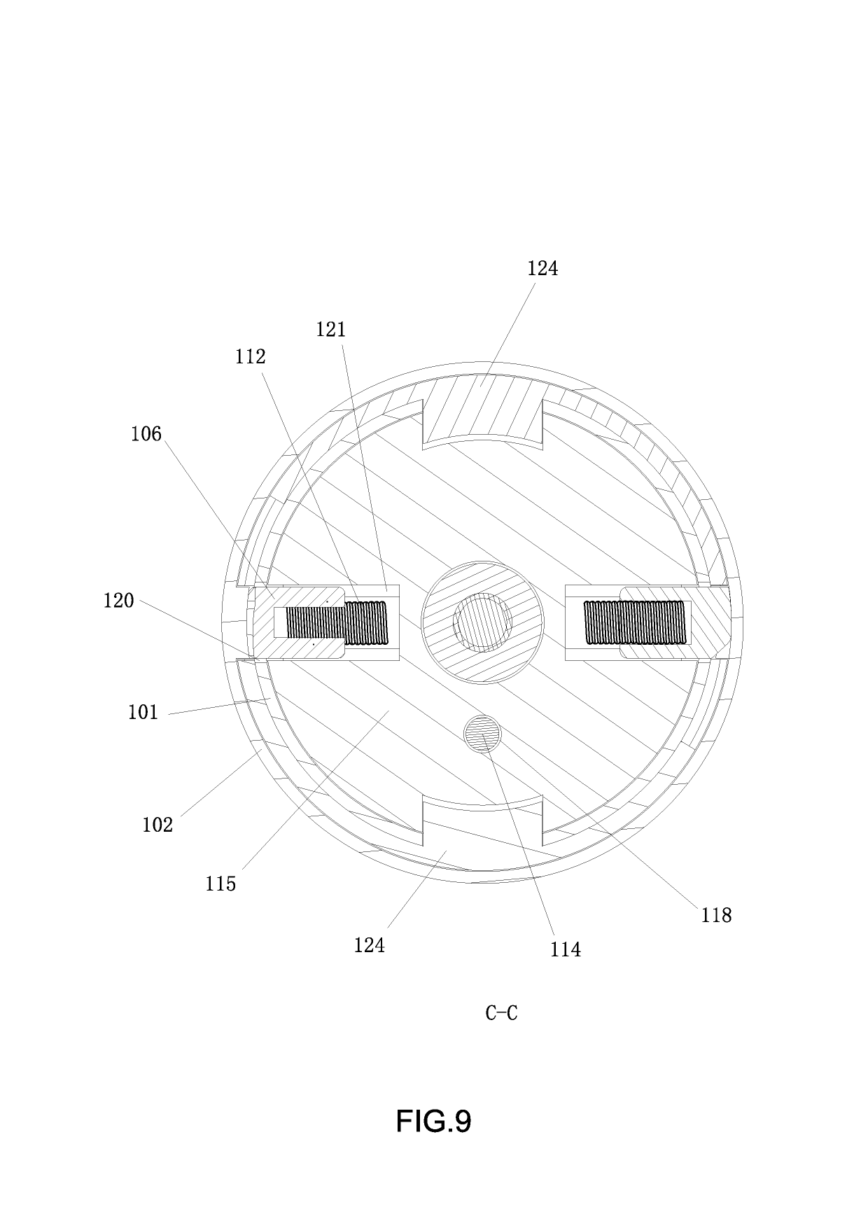

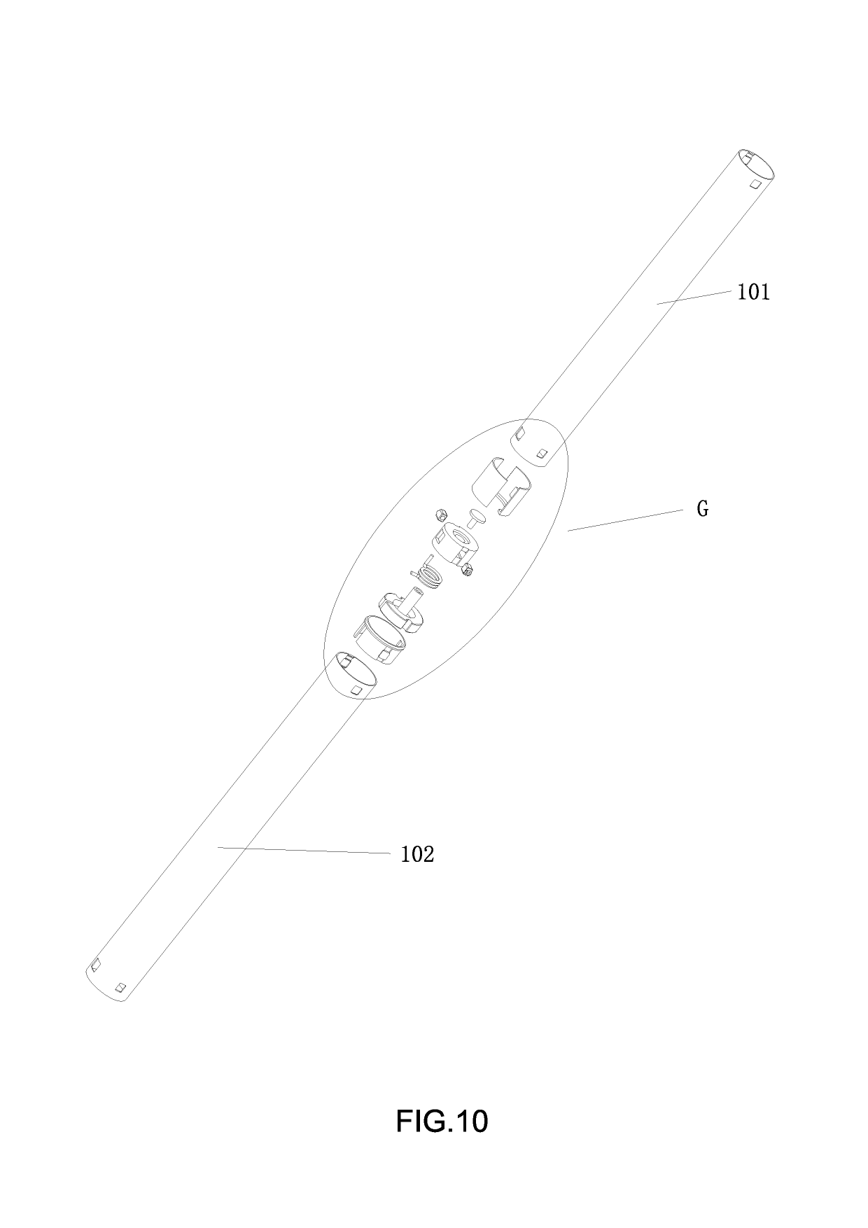

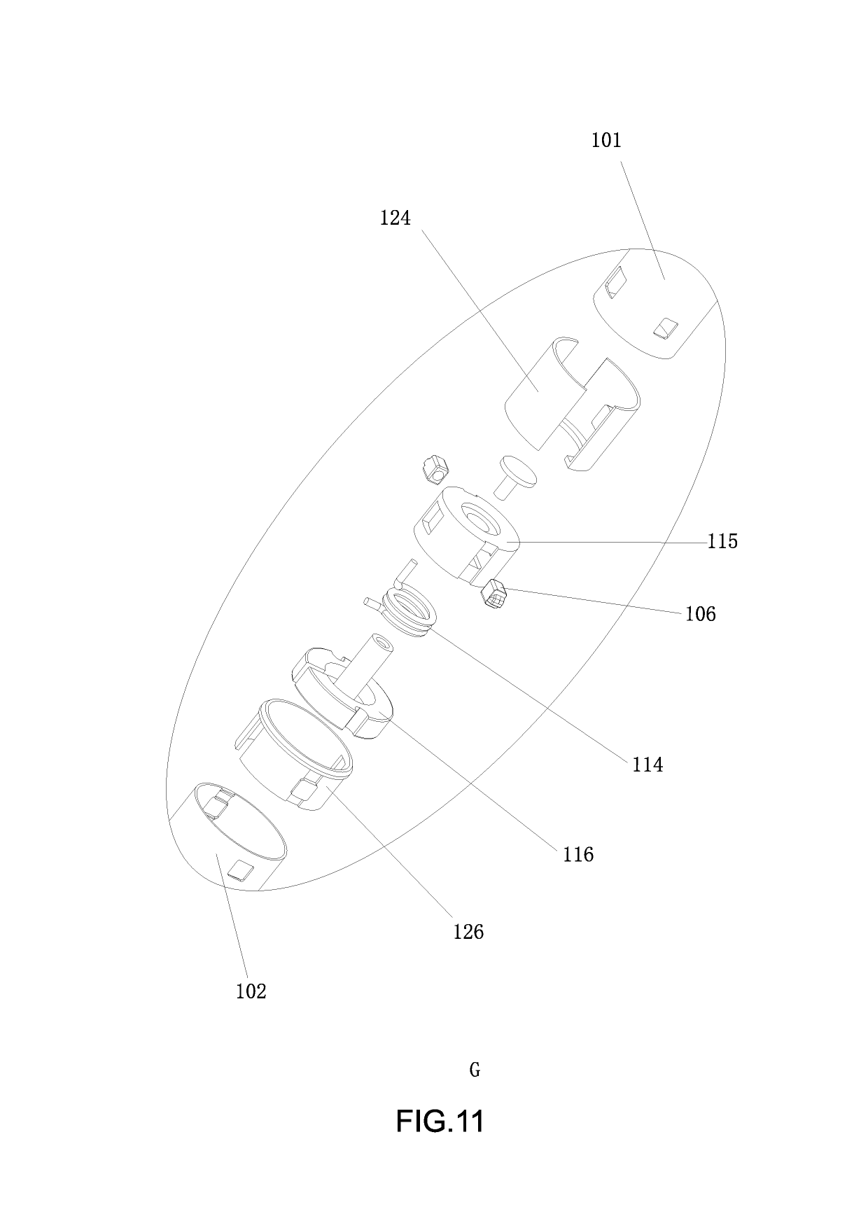

As shown in FIGS. 1-11, a telescopic pipe with a toothed locking structure is applied to photography auxiliary equipment such as selfie sticks and tripods. It includes a plurality of pipe fittings 100 that are sequentially connected, in adjacent two pipe fittings 100, one pipe fitting 100 is defined as a front pipe 101, and the other pipe fitting 100 is defined as a rear pipe 102. The rear pipe 102 has an adjustment hole 103 and a plurality of limit teeth 104. The plurality of limit teeth 104 are protruded from a wall of the adjustment hole 103 and are spaced apart in a length direction of the adjustment hole 103 to form a plurality of limit grooves 105. One end of the front pipe 101 is inserted into the adjustment hole 103 and can move relative to the rear pipe 102 along the adjustment hole 103. One end of the front pipe 101 inserted into the rear pipe 102 is movably connected to a clamp block 106 that is inserted and matched with the limit grooves 105. The clamp block 106 is driven to move away from the limit grooves 105 by the limit teeth 104 when the front pipe 101 moves relative to the rear pipe 102, and then moved into an adjacent other limit grooves 105. This embodiment provides the telescopic pipe with a toothed locking structure to solve problems of locking a telescopic state of the existing telescopic rod through one clamp block and one socket, with a fixed stretching length and inconvenient use. The main solution is to configure the plurality of limit teeth 104 forming by the plurality of limit grooves 105 that are spaced apart one the rear pipe 102, and configuring the clamp block on the front pipe 101, the clamp block is inserted and matched with the limit grooves 105 and is driven by the limit teeth 104 to move from the limit grooves 105 and move into another limit groove when the front pipe 101 moves relative to the rear pipe 102, so that the front pipe 101 can be locked and unlocked in its moving direction. That is, when the front pipe 101 moves relative to the rear pipe 102, it can be locked and unlocked by a cooperation of one clamp block 106 and the plurality of limit grooves 105, so as to achieve a locking under various stretching lengths, with diverse stretching lengths and convenient use.

Where, the limit grooves 105 has a front pushing surface 107, and the front pushing surface 107 is located in front of the clamp block 106 when the clamp block 106 is inserted and matched with the limit grooves 105. The front pushing surface 107 is inclined from an interior to an outer towards the back; the clamp block 106 has a rear pushing surface 108 that matches with the front pushing surface 107. The above setting is achieved by configuring one side of the limit grooves 105 that is in front of the clamp block 106 to tilt from the inside out towards the back, and configuring the side of the clamp block 106 that is opposite to the front pushing surface 107 cooperating with the front pushing surface 107, so that the front pipe 101 can move forward smoothly relative to the rear pipe 102 when stretching, and a stretching effect is good.

Where, the limit grooves 105 have a rear contact surface 109, which is located behind the clamp block 106 when the clamp block 106 is inserted and matched with the limit grooves 105. The rear contact surface 109 is extended radially along the front pipe 101, and the clamp block 106 has a front contact surface 110 that is parallel to the rear contact surface 109. The above setting is achieved by configuring one side of the limit grooves 105 that is behind the clamp block 106 extending radially along the front pipe 101, and configuring the side of the clamp block 106 that is opposite to the rear contact surface 109 being parallel to the rear contact surface 109, so that when the clamp block 106 is inserted into the limit grooves 105, the front pipe 101 is less likely to retract backwards into the rear pipe 102, thus having a better locking effect.

In an implementation mode, the rear pushing surface 108 and the front contact surface 110 are slowly transited.

In an implementation mode, the plurality of limit teeth 104 spaced apart in the length direction of the adjustment hole 103 form a limit gear rack 111. There are two limit gear racks 111 and two clamp blocks 106, they correspond one to one. The two clamp blocks 106 are opposite in a radial direction of the front pipe 101 and staggered in an axial direction of the front pipe 101. The two clamp blocks 106 synchronously move into or out of corresponding limit grooves 105 when the front pipe 101 moves relative to the rear pipe 102. The above setting achieves a good locking effect between the front pipe 101 and the rear pipe 102 by configuring the two limit gear racks 111 and the two clamp blocks 106. Due to a fact that the two clamp blocks 106 are opposite in the radial direction of the front pipe 101 and staggered in the axial direction of the front pipe 101, when the two clamp blocks 106 are respectively inserted into the corresponding limit grooves 105, the front pipe 101 can be locked at different positions in the axial direction on the rear pipe 102, and have good locking effect.

In an implementation mode, the front pipe 101 is provided with an elastic member 112 that drives the clamp block 106 to move into the limit grooves 105. Specifically, the elastic member 112 is a spring. The above setting is achieved by configuring the elastic member 112 inside the front pipe 101 to drive the clamp block 106 into the limit grooves 105, so that the clamp block 106 can be driven away from the limit grooves 105 by the limit teeth 104 and moved into the adjacent other limit grooves 105 when the front pipe 101 moves relative to the rear pipe 102. The structure is simple and easy to implement.

In an implementation mode, a positioning hole 113 is formed on the clamp block 106 configured for one end of the elastic member 112 being inserted. The above setting is achieved by configuring the positioning hole 113 on the clamp block 106 for one end of the elastic member 112 to be inserted, thereby ensuring stable assembly of the elastic member 112 and the clamp block 106.

In an implementation mode, the front pipe 101 can rotate relative to the rear pipe 102, and the clamp block 106 is caused to move away from the limit grooves 105 in a circumferential direction of the front pipe 101. The front pipe 101 and the rear pipe 102 are provided with a reset piece 114. When the front pipe 101 rotates relative to the rear pipe 102, the reset piece 114 causes the front pipe 101 to have a reverse rotation tendency, so that the clamp block 106 is moved, reset and clamped into the limit grooves 105. The above setting is achieved by configuring the front pipe 101 to be able to rotate relative to the rear pipe 102, and configuring the reset piece 114 on the front pipe 101 and the rear pipe 102, which causes the front pipe 101 to have a reverse rotation tendency when the front pipe 101 is rotated relative to the rear pipe 102. This allows the front pipe 101 to rotate and unlock (the clamp block 106 moves away from the limit grooves 105), retract backwards, and rotate to reset and lock (the clamp block 106 is re-inserted into the limit grooves 105), rendering the operation fast and simple.

In an implementation mode, the front pipe 101 is provided with a front connector 115 that moves and rotates synchronously with the rear pipe, and the adjustment hole 103 is provided with a rear connector 116 that rotates synchronously with the rear pipe 102. The rear connector 116 is rotatably connected to the front connector 115 and can move synchronously with the front pipe 101 relative to the rear pipe 102. The reset piece 114 is a torsion spring with one end connected to the front connector 115 and at the other end connected to the rear connector 116. The front connector 115 is provided with the clamp block 106 and the elastic member 112 that drives the clamp block 106 to move into the limit grooves 105. The above setting is achieved by configuring the front connector 115 in the front pipe 101, the rear connector 116 in the rear pipe 102, the clamp block 106 and the elastic member 112 on the front connector 115, and the reset piece 114 is a torsion spring with one end connected to the front connector 115 and the other end connected to the rear connector 116 respectively, so that the front pipe 101 has a tendency to rotate in an opposite direction when it rotates relative to the rear pipe 102. The structure is simple and compact.

In an implementation mode, the front connector 115 and the rear connector 116 are enclosed to form a receiving cavity 117 for accommodating the reset piece 114. The front connector 115 is provided with a front fixing hole 118 configured for one end of the reset piece 114 being inserted, and the rear connector 116 is provided with a rear fixing hole 119 configured for the other end of the reset piece 114 being inserted. The above configuration forms a receiving cavity 117 by enclosing the front connector 115 and the rear connector 116. The reset piece 114 is accommodated in the receiving cavity 117 and its two free ends are respectively inserted and matched with the front connector 115 and the rear connector 116. Therefore, a connection between the reset piece 114, the front connector 115, and the rear connector 116 is stable and has good repositioning ability.

In an implementation mode, the rear connector 116 has a positioning column that extends from the receiving cavity 117 towards the front connector 115 and is rotatably connected to the front connector 115, and the reset piece 114 penetrates the positioning column. Due to the positioning column of the rear connector 116, the reset piece 114 penetrates the positioning column, which ensures a stable assembly of the reset piece 114.

In an implementation mode, the front pipe 101 is provided with a through hole 120 configured for the clamp block 106 to pass out, and the front connector 115 is provided with a guide hole 121 configured for the clamp block 106 and the elastic member 112 to be inserted. The clamp block 106 is extended or retracted from the through hole 120 along the guide hole 121 into the front pipe 101. The above setting is achieved by configuring the guide hole 121 on the front connector 115 for the clamp block 106 and the elastic member 112 to be inserted, and configuring the through hole 120 on the front pipe 101 for extending or retracting the clamp block 106, so as to ensure a stable assembly of the front connector 115, the front pipe 101, the clamp block 106, and the elastic member 112.

In an implementation mode, the rear connector 116 is provided with a limit gear groove 122 that cooperates with the limit gear rack 111 to restrict a rotation of the rear connector 116 relative to the rear pipe 102. The above setting is achieved by configuring the limit gear groove 122 on the rear connector 116 that cooperates with the limit gear rack 111 to restrict the rotation of the rear connector 116 relative to the rear pipe 102, so that the rear connector 116 can move along the rear pipe 102 and be fixed in the circumferential direction with the rear pipe 102. The structure is simple, and the implementation is convenient.

In an implementation mode, the front pipe 101 is spaced apart from a wall of the adjustment hole 103 to form an assembly gap (not marked in the figure). One end of the front pipe 101 inserted into the rear pipe 102 is provided with a damping plate 124 accommodated in the assembly gap. There are two damping plates 124, and the two damping plates 124 are arranged opposite to each other in the radial direction of the front pipe 101 to form a guiding gap that cooperates with the limit gear rack 111 (not marked in the figure). The above setting is achieved by providing the damping plates 124 between the front pipe 101 and the rear pipe 102, which gives the front pipe 101 to have a sense of jerkiness when moving relative to the rear pipe 102, and increases a friction between the two pipes after moving into place (in the locked state), resulting in excellent locking effect.

In an implementation mode, one end of the rear pipe 102 is provided with a stopper 126 configured for the front pipe to be inserted, a part of the stopper is extends into the adjustment hole 103 to limit the front pipe 101 to move away from the rear pipe 102 by abutting against front and rear the damping plates 124. The above setting is achieved by configuring the stopper 126 on the rear pipe 102, which partially extends into the adjustment hole 103 and abuts against the damping plates 124 to restrict the movement of the front pipe 101 away from the rear pipe 102. This ensures a stable assembly of the front pipe 101 and the rear pipe 102, and prevents the front pipe 101 from detaching.

It should be noted that outer wall of the pipe fittings 100 can be, but is not limited to, circular, rhombus, notched, or elliptical in shape.

What is claimed is:

1. A telescopic pipe with a toothed locking structure, comprising a plurality of sequentially connected pipe fittings;
wherein in adjacent two pipe fittings, one pipe fitting is defined as a front pipe, and the other pipe fitting is defined as a rear pipe;
wherein the rear pipe has an adjustment hole and a plurality of limit teeth; the plurality of limit teeth are protruded from a wall of the adjustment hole and are spaced apart in a length direction of the adjustment hole to form a plurality of limit grooves;
one end of the front pipe is inserted into the adjustment hole and is capable of moving relative to the rear pipe along the adjustment hole,
wherein one end of the front pipe inserted into the rear pipe is movably connected with a clamp block that matches with the limit grooves,
when the front pipe moves relative to the rear pipe, the clamp block is driven to move away from the limit grooves by the limit teeth and move into another adjacent limit groove.

2. The telescopic pipe with a toothed locking structure according to claim 1, wherein the limit grooves have a front pushing surface, the front pushing surface is located in front of the clamp block when the clamp block is inserted and matched with the limit grooves;
the front pushing surface is inclined from an interior to an outside towards the back;
the clamp block has a rear pushing surface that is matched with the front pushing surface;
the limit grooves have a rear contact surface, which is located behind the clamp block when the clamp block is inserted and matched with the limit grooves;
the rear contact surface is extended radially along the front pipe;
the clamp block has a front contact surface that abuts against a front and a rear of the rear contact surface;
the front contact surface and the rear contact surface are parallel to each other.

3. The telescopic pipe with a toothed locking structure according to claim 1, wherein the plurality of limit teeth spaced apart in the length direction of the adjustment hole form a limit gear rack;
there are two limit gear racks and two clamp blocks, they correspond one to one;
the two clamp blocks are opposite in a radial direction of the front pipe and staggered in an axial direction of the front pipe,
the two clamp blocks synchronously move in or move out of corresponding limit grooves when the front pipe moves relative to the rear pipe.

4. The telescopic pipe with a toothed locking structure according to claim 1, wherein the front pipe is provided with an elastic member that drives the clamp block to move into the limit grooves;
a positioning hole is formed on the clamp block configured for one end of the elastic member being inserted.

5. The telescopic pipe with a toothed locking structure according to claim 1, wherein the front pipe is capable of being rotated relative to the rear pipe to cause the clamp block to move away from the limit grooves in a circumferential direction of the front pipe;
a reset piece is provided on the front pipe and the rear pipe;
when the front pipe rotates relative to the rear pipe, the reset piece causes the front pipe to rotate reverse, so that the clamp block is moved, reset and clamped into the limit grooves.

6. The telescopic pipe with a toothed locking structure according to claim 5, wherein the front pipe is provided with a front connector that moves and rotates synchronously with the front pipe;
the adjustment hole is provided with a rear connector that rotates synchronously with the rear pipe;
the rear connector is rotatably connected to the front connector and is capable of moving synchronously with the front pipe relative to the rear pipe;
the reset piece is a torsion spring with one end connected to the front connector and the other end connected to the rear connector;
the front connector is provided with the clamp block and the elastic member that drives the clamp block to move into the limit grooves.

7. The telescopic pipe with a toothed locking structure according to claim 6, wherein the front connector and the rear connector are enclosed to form a receiving cavity for accommodating the reset piece;
the front connector is provided with a front fixing hole configured for one end of the reset piece being inserted, and the rear connector is provided with a rear fixing hole configured for the other end of the reset piece being inserted.

8. The telescopic pipe with a toothed locking structure according to claim 6, wherein the front pipe is provided with a through hole configured for the clamp block to pass through;
the front connector is provided with a guide hole configured for the clamp block and the elastic member to be inserted;
the clamp block is extended or retracted from the through hole along the guide hole into the front pipe.

9. The telescopic pipe with a toothed locking structure according to claim 6, wherein the plurality of limit teeth spaced apart in the length direction of the adjustment hole form the limit gear rack;
the rear connector is provided with a limit gear groove that cooperates with the limit gear rack to limit a rotation of the rear connector relative to the rear pipe.

10. The telescopic pipe with a toothed locking structure according to claim 3, wherein the front pipe is spaced apart from a wall of the adjustment hole to form an assembly gap;
one end of the front pipe inserted into the rear pipe is provided with a damping plate accommodated in the assembly gap;
there are two damping plates, and the two damping plates are arranged opposite to each other in the radial direction of the front pipe to form a guiding gap that cooperates with the limit gear rack;
one end of the rear pipe is provided with a stopper configured for the front pipe to be inserted;
a part of the stopper is extended into the adjustment hole to limit the front pipe to move away from the rear pipe by abutting against front and rear of the damping plates.
